(19) United States
(12) Patent Application Publication
(10) Pub. No.: US 2017/0271971 A1
(43) Pub. Date: Sep. 21, 2017

(54) MAGNETIC COUPLING

(71) Applicant: Mahle International GmbH, Stuttgart (DE)

(72) Inventors: Thomas Riemay, Korb (DE); Rolf Mueller, Steinheim/Murr (DE)

(21) Appl. No.: 15/314,935

(22) PCT Filed: May 27, 2015
(86) PCT No.: PCT/EP2015/061719

§ 371 Date: May 26, 2017

(30) Foreign Application Priority Data
May 30, 2014 (DE) 10 2014 210 299.5

(51) Int. Cl. H02K 49/10; F01D 15/00; F01D 25/24; H02K 49/06; F02B 37/00

(52) U.S. Cl. CPC H02K 49/102; H02K 49/106; H02K 49/06; F02B 37/00; F01D 25/24; F01D 15/00; F05D 2220/40

(57) ABSTRACT

A magnetic coupling may include a stator having a first axial portion which merges with a second axial portion along an axial direction, the second axial portion being adjustable relative to the first axial portion along a circumferential direction. The magnetic coupling may also include a first rotor and a second rotor each rotationally adjustable relative to the stator about a rotational axis which runs along an axial direction, the second rotor arranged concentrically with respect to the first rotor. The first axial portion, the second axial portion, and the first and second rotors may each include respective magnet elements arranged in pairs having alternating magnetic polarity along the circumferential direction.

### CROSS REFERENCE TO RELATED APPLICATIONS

This application claims priority to German Patent Application No. DE 10 2014 210 299.5, filed on May 30, 2014, and International Patent Application No. PCT/EP2015/061719, filed on May 27, 2015, both of which are hereby incorporate by reference in their entirety.

### TECHNICAL FIELD

The invention relates to a magnetic coupling and to a device for utilizing waste heat having such a magnetic coupling. The invention also relates to a motor vehicle having such a waste heat utilizing device.

### BACKGROUND

Devices which are based on the contactless transmission of rotational movements using the magnetic interaction are generally referred to as magnetic couplings. Such magnetic couplings are used according to the prior art to transmit torques in a contactless fashion across an air gap and through walls, for example of hermetically sealed containers.

Conventional magnetic couplings are based on the same functional principle as what are referred to as synchronous motors. In a synchronous motor, the effect of the transmission of torque by magnetic interaction is utilized by arranging on the circumference of a stator windings which can be energized electrically and with which, through corresponding alternating energization, an alternating magnetic field which migrates in the circumferential direction can be generated. Thus, a rotor can be “entrained”. A magnetic coupling differs from such a synchronous motor essentially only in that the rotating alternating magnetic field is generated by rotating rotor parts or annular parts of a first rotor with permanently magnetized elements or magnetizable elements which are adjacent in the circumferential direction, specifically on the input side of the magnetic gear mechanism. The second rotor which interacts with the rotating alternating magnetic field and has permanently magnetized or ferromagnetic elements is mounted on the output side.

The desired transmission of torque between the two rotors is performed by means of the magnetic interaction of the magnets of the first rotor with those of the second rotor.

Pole pins made of ferromagnetic material or magnets can also be provided here on the stator. Given suitable dimensioning of the number of pole pins relative to the number of magnet elements of the two rotors, the stator brings about modulation of the alternating magnetic field generated by the drive-side rotor, in such a way that the alternating magnetic field acting on the output-side rotor causes the second rotor to rotate at a rotational frequency which is less than that of the drive-side rotor. In this case, the magnetic coupling follows the functional principle of a magnetic gear mechanism.

However, in conventional magnetic couplings it proves disadvantageous that the drive connection which is present between the two rotors typically cannot be interrupted in terms of what is referred to as idling or freewheeling. However, owing to practical considerations this would be of considerable benefit for various applications of generic magnetic couplings, for example if it is to be used as a magnetic gear mechanism in a waste heat utilizing apparatus.

### SUMMARY

The invention therefore has the object of providing an improved embodiment of a magnetic coupling in which, in particular, the drive connection between the two rotors can be optionally switched on or off.

This object is achieved by means of the subject matter of the independent patent claims. Preferred embodiments are the subject matter of the dependent claims.

The basic concept of the invention is accordingly to embody the stator of the magnetic coupling in two parts with two axial portions along its axial direction, with the result that the first axial portion is adjustable relative to the second axial portion in the rotational direction of the entire stator. Since the two axial portions are equipped alternately with magnet elements with opposing polarity along the circumferential direction, the magnet elements of the two axial portions can be arranged by suitable relative rotation with respect to one another in such a way that the two magnet elements, adjacent along the axial direction, of the first and second axial portions also have opposing polarity.

However, in this case, the magnetic fields which are generated by the permanent magnets of the two axial portions virtually or even completely neutralize one another, with the result that the stator is no longer capable of performing its actual function, the transmission or modulation of the alternating magnetic field generated by the drive-side rotor. As a result, torque is no longer transmitted between the two rotors. Therefore, there is no drive connection any more between the two rotors, i.e. the magnetic coupling is in the freewheeling mode.

This state is cancelled again, and the desired drive coupling between the two rotors restored, by adjusting back the two axial portions in such a way that the magnet elements which are adjacent along the axial direction exhibit a respective identical polarity.

A magnetic coupling according to the invention comprises a stator which has a first axial portion which merges with a second axial portion along the one axial direction, and can be adjusted relative to the first axial portion along its circumferential direction. A first rotor is rotationally adjustable relative to the stator about a rotational axis which runs along the axial direction. A second rotor is in turn arranged concentrically with respect to the first rotor. The second rotor is also rotationally adjustable relative to the stator about the rotational axis. The first axial portion of the stator comprises here first axial portion magnet elements which are arranged in pairs having alternating magnetic polarity along the circumferential direction of the stator. In analogous fashion, the second axial portion of the stator also comprises second axial portion magnet elements which are also arranged in pairs having alternating magnetic polarity along the circumferential direction of the stator. Finally, the first and second rotors each also have rotor magnet elements which are arranged in pairs having alternating magnetic polarity along a circumferential direction of the respective rotor.

In one preferred embodiment, the rotor magnet elements and the axial portion magnet elements can each be polarized radially. This means that either the magnetic north pole of an element is arranged radially on the inside and correspondingly the magnetic south pole is arranged radially on the outside, or vice versa. However, other types of magnetization are also conceivable in variants, for example a radial or lateral (Halbach) magnetization or parallel magnetization.

In one particularly preferred embodiment, the two rotors and the stator are each embodied essentially in an annular shape and arranged concentrically with respect to the rotational axis in each case in a cross section measured along the axial axis.

In a further preferred embodiment, the second axial portion can be adjustable relative to the first axial portion between a first and a second position in the circumferential direction. In the first position of the second axial portion, axial portion magnet elements, adjacent along the axial direction, of the first and second axial portions have the same polarity. If the axial portion magnet elements are polarized in the radial direction, this means that the magnetic south pole is provided radially on the inside and the magnetic north pole is provided radially on the outside, or vice versa, in the axial portion magnet elements of both the first axial portion and the second axial portion. Therefore, in the first position, the magnetic field lines generated by the magnets of the first and second axial portions are, when considered in cross section perpendicularly with respect to the axial direction, virtually or completely identical, i.e. the two-part first rotor has the same properties in the first position of the second axial portion as a conventional single-part stator.

In contrast, the magnet elements which are adjacent along the axial direction have opposing polarities to one another in the second position of the second axial portion. This causes the magnetic field lines which are generated by the magnet elements of the two axial portions to largely or even completely cancel one another out in the manner of destructive interference, with the result that only an effective magnetic field with a low field strength can be formed. Subsequently, only low-degree coupling also occurs between the first rotor and the second rotor are formed, which means that the magnetic coupling is in the freewheeling mode. In other words, the magnetic drive connection between the two rotors is interrupted.

In one advantageous development, the second axial portion can be adjustable into an intermediate position in which it is located between the first and second positions. This permits the strength of the magnetic field generated by the axial portion magnet elements of the stator to be set between a maximum value, when the second axial portion is in the first position, and a minimum value, in the extreme case a zero value, when the second axial portion is in the second position. This permits the degree of coupling between the first and second rotors to be set between a maximum value and a minimum value—in an extreme case the latter can be a zero value.

With respect to the radial arrangement of the stator and of the two rotors relative to one another, various structural options are available to a person skilled in the art. In a first variant, the first rotor can be embodied as an inner rotor, the second rotor can be embodied as a central rotor which is arranged radially on the outside with respect to the latter, and the stator can be embodied as an outer stator which is arranged radially outside the inner rotor and the central rotor. In an alternative, second variant to this, the first rotor can be embodied as an outer rotor, the second rotor can be embodied as an inner rotor, and the stator can be embodied as a central stator which is arranged radially between the outer rotor and the inner rotor. In a further, third alternative, the first rotor can finally be embodied as a central rotor, the second rotor can be embodied as an outer rotor, and the stator can be embodied as an inner stator which is arranged radially inside the central rotor and the outer rotor.

Various options are also possible with respect to the structural configuration of the rotor magnet elements. These can particularly expediently be embodied as magnetic pole pins composed of a ferromagnetic material. Each of the pole pins extends here along the axial direction of the magnetic coupling, wherein the pole pins are arranged at a distance from one another with respect to the circumferential direction, and pole pins which are adjacent in the circumferential direction have opposing polarity.

For the rotor magnet elements of the outer rotor—in the event of the stator being an inner stator—or for the axial portion magnet elements of the outer stator it is proposed in one embodiment which is particularly easy to implement in terms of production technology that said magnet elements be embodied as radially polarized permanent magnets. The permanent magnets are arranged in pairs having alternating polarity in the circumferential direction in such a way that in each case a magnetic south pole follows a magnetic north pole along the circumferential direction. In alternative embodiments, other types of magnetization, for example parallel or lateral magnetization, can also be selected.

In an analogous fashion, for the rotor magnet elements of the inner rotor—in the event of the stator being an outer stator—or for the axial portion magnet elements of the inner stator, it is also recommended to implement said magnet elements as radially magnetized permanent magnets. The permanent magnets of the inner rotor or inner stator are also arranged in pairs having alternating polarity in the circumferential direction, with the result that in each case a magnetic south pole follows a magnetic north pole along the circumferential direction.

The magnetic coupling can particularly expediently be embodied in the manner of a magnetic gear mechanism. If the magnetic coupling is to be used as a magnetic gear mechanism in a device for utilizing waste heat, it is proposed to embody the magnetic gear mechanism in such a way that it steps down the rotational speed of the first rotor.

In order to technically implement said magnetic gear mechanism, which steps down a rotational speed of the first rotor, it is proposed to define the number of rotor magnet elements of the two rotors and the number of pole pins in such a way that the sum of the pole pins corresponds to the sum of the number of the pole pairs of the rotor magnet elements of the first rotor and to the number of the pole pairs of the rotor magnet elements of the second rotor.

The invention also relates to a device for utilizing waste heat, in particular the waste heat of an exhaust system in motor vehicles. The device comprises a high-revving turbine which is driven by a fluid which can be heated by means of the waste heat, which high-revving turbine is arranged in a region which is closed off by a hermetically sealed partition to prevent loss of fluid, and which high-revving turbine has, on the outside of the partition, a contact-free drive coupling on the output side to an apparatus which is provided for utilizing the turbine work. A magnetic coupling having one or more of the features specified above and having a drive shaft which is provided in the closed-off region and is connected in a rotationally fixed fashion to the second rotor serves as an arrangement for the drive coupling. On the outside of the partition, an output shaft is provided which is in turn connected in a rotationally fixed fashion to the first rotor.

Further important features and advantages of the invention can be found in the dependent claims, the drawings and the associated description of the figures with reference to the drawings.

Of course, the features mentioned above and those still to be explained below can be used not only in the respectively specified combination but also in other combinations or alone without departing from the scope of the present invention.

Preferred exemplary embodiments of the invention are illustrated in the drawings and will be explained in more detail in the following description, wherein identical reference symbols relate to identical or similar or functionally identical components.

### BRIEF DESCRIPTION OF THE DRAWINGS

In the figures, in each case in a schematic form:

FIG. 1 shows an example of a magnetic coupling according to the invention in an exploded illustration,

FIG. 2 shows the magnetic coupling in FIG. 1 in a non-mounted state,

FIG. 3 shows the magnetic coupling in FIG. 1 in a mounted state,

FIGS. 4/5 show the two axial portions of the stator of the magnetic coupling which are essential to the invention and can be adjusted with respect to one another, in a longitudinal section along the axial direction A in different positions,

FIGS. 6-11 show various structural embodiments of the magnetic coupling according to the invention, and

FIG. 12 shows the magnetic coupling according to the invention as part of a waste heat utilizing apparatus.

### DETAILED DESCRIPTION

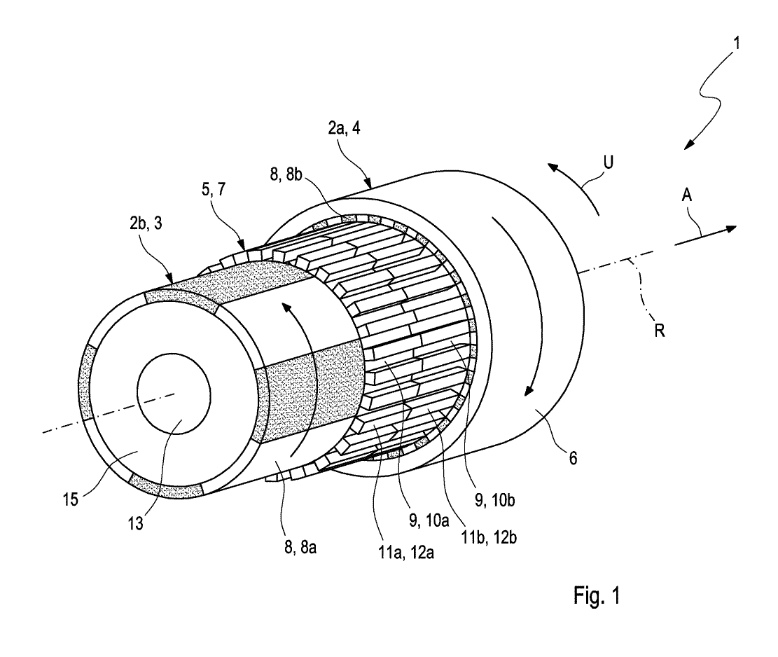

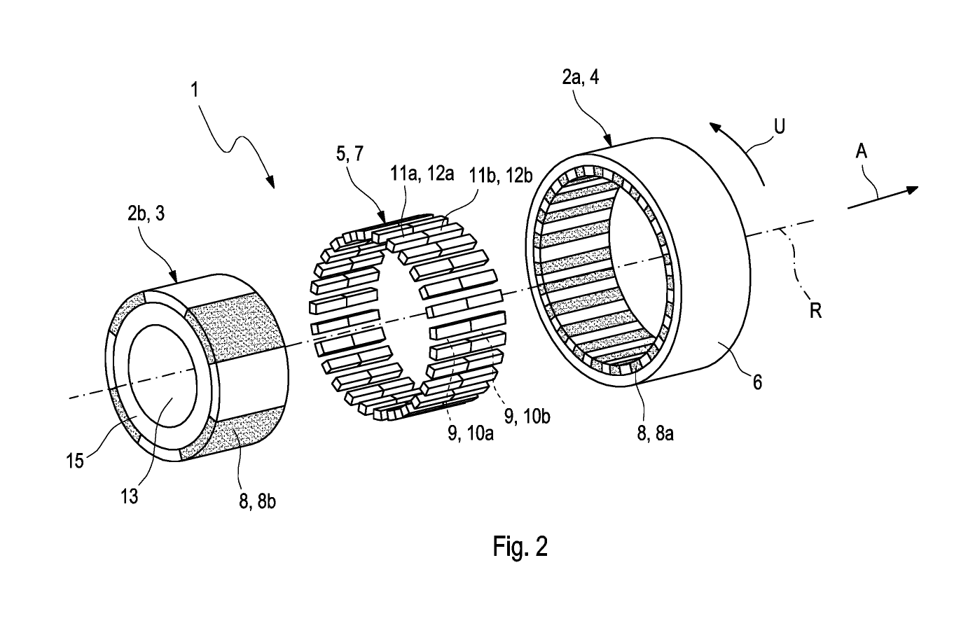

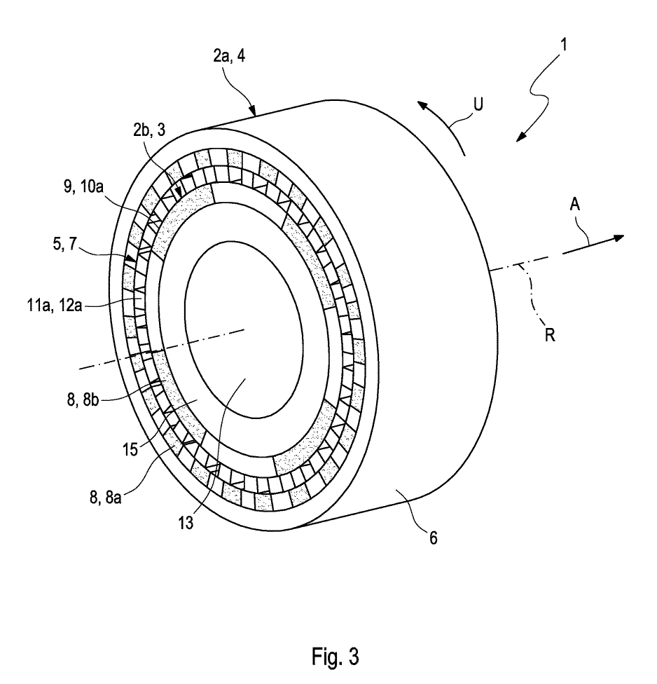

FIG. 1 illustrates a first example of a magnetic coupling 1 according to the invention in an exploded illustration. FIG. 2 shows the same magnetic coupling 1 in a non-mounted state, and FIG. 3 shows said magnetic coupling 1 in a mounted state.

As is apparent from FIGS. 1 to 3, the magnetic coupling 1 comprises a stator 5, a first rotor 2a conceived as an outer rotor 3, and a second rotor 2b embodied as an inner rotor 4. The two rotors 2a, 2b are rotationally adjustable about a common rotational axis R. In a cross section which is defined orthogonally with respect to the rotational axis R, the two rotors 2a, 2b have an annular geometry, as does the stator 5. The outer rotor 4 comprises here a casing 6 made of a magnetizable material. The outer rotor 4 is also equipped with rotor magnet elements 8 which are configured here in the form of radially magnetized permanent magnets 8a (cf. FIG. 2) which are attached to the inner circumference of the casing 6, specifically along a circumferential direction U of the outer rotor 4, having alternating radial polarity. Along the circumferential direction U, a magnetic south pole therefore alternates with a magnetic north pole. The inner rotor 3 has a body in the form of a shaft 13 on whose outer circumference rotor magnet elements 8 are also provided in the form of radially magnetized permanent magnets 8b, in a fashion analogous to the outer rotor 4.

The radial polarity of the permanent magnets 8b also alternates along the circumferential direction U. In variants of the example, lateral or parallel magnetization can also be selected for the rotor magnet elements 8 instead of radial magnetization. The permanent magnets 8a, 8b can be manufactured from a ferromagnetic material such as iron, cobalt or nickel.

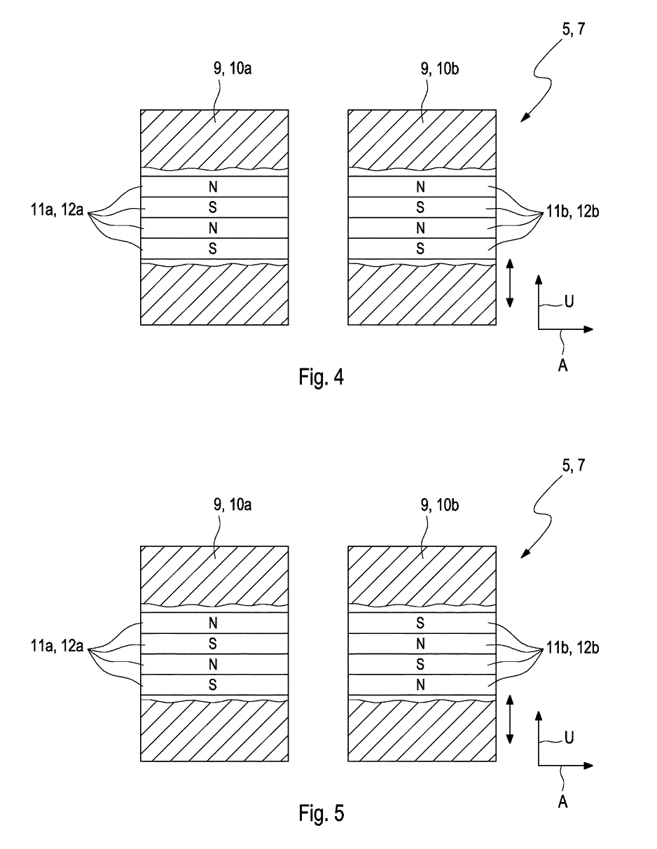

It proves essential to the invention to divide the stator 5, embodied in the form of a hollow cylindrical intermediate wall 9 in the exemplary scenario, into a first and a second axial portion 10a, 10b with respect to an axial direction A of the magnetic coupling 1, wherein the axial direction A extends parallel to the rotational axis R. In other words, in order to form the two axial portions 10a, 10b, the intermediate wall 9 is formed in two parts along the axial direction A. In this context, the adjustability of the two axial portions 10a, 10b with respect to one another along the circumferential direction U is essential. For the sake of clarity, such adjustability is illustrated in the separate, highly schematic illustration in FIG. 4.

However, reference is firstly made again to FIG. 1 which shows that magnet elements are provided on both the first and second axial portions 10a, 10b, said magnet elements being denoted below as the first and second axial portion magnet elements 11a, 11b. They are each implemented in the form of pole pins 12a, 12b which extend along the axial direction and are composed of a ferromagnetic material and the radial polarity of which alternates in the circumferential direction U like that of the permanent magnets 8a, 8b, a rotation of the two axial portions 10a, 10b with respect to one another brings about a change in the radial polarity of the pole pins 12a, 12b, adjacent in the axial direction, of the first and second axial portions 10a, 10b. In variants of the example, instead of a radial magnetization it is also possible to select another type of magnetization, for example parallel or lateral (Halbach) magnetization.

If the illustration in FIG. 4 is now considered, it becomes apparent that the first axial portion 10a of the stator 5 of the magnetic coupling 1 is arranged in a positionally fixed fashion while the second axial portion 10b is adjustable relative to the first axial portion 10a in the circumferential direction U between a first and a second position. FIG. 4 shows the second axial portion 10b in the first position, which is characterized in that two axial portion permanent magnets 11a, adjacent in the axial direction A, of the first and second axial portions 10a, 10b have the same polarity. A pole pin 12a of the first axial portion 10a with a magnetic north pole N radially on the inside and a magnetic south pole S radially on the outside is therefore followed by a pole pin 12b along the axial direction A in the second axial portion 10b, the magnetic north pole N of which pole pin 12b is also arranged radially on the inside and merges with a magnetic south pole S radially toward the outside. The same applies to a pole pin 12a with a magnetic north pole N radially on the outside and a magnetic south pole S radially on the inside; the pole pin 12b which is adjacent to this pole pin 12a in an axial direction then also has a magnetic north pole radially on the outside and a magnetic south pole N radially on the inside. The configuration of the stator 5 with the second axial portion 10b in its first position therefore corresponds to the configuration of a conventional stator.

If the inner rotor 3 rotates with the permanent magnets 8b in the circumferential direction U, the magnetic fields generated by the permanent magnets 8b are modulated by the pole pins 12a, 12b on the fixed intermediate wall 9, with the result that the outer rotor 4, and correspondingly the casing 6 with the permanent magnets 8a, rotates counter to the circumferential direction U. The magnetic coupling operates in a nominal fashion in this case. By suitably defining the number of permanent magnets 8a on the outer rotor 4 and the number of permanent magnets 8b on the inner rotor 3 relative to the number of pole pins 12a and 12b it is possible here to achieve down stepping of the rotational speed of the outer rotor 4 to the inner rotor 3, with the result that the magnetic coupling 1 additionally acts as a magnetic gear mechanism.

FIG. 5 shows the second axial portion 10b in its second position into which it has been adjusted from its first position illustrated in FIG. 4, by rotation along the circumferential direction U. This adjustment may take place in or counter to the circumferential direction U here. The adjustment of the second axial portion 10a, which has taken place according to FIG. 5 from the first position into the second position, results in the radial polarity in the axial direction A of adjacent axial portion magnet elements 11a, 11b, that is to say of the pole pins 12a, 12b, alternating. In other words, a pole pin 12a with the polarity of a north pole N radially on the outside and that of a south pole S radially on the inside is followed in the axial direction A by a pole pin 12b with the polarity of a south pole S radially on the inside and that of a north pole N radially on the outside, and vice versa. However, in this way the magnetic fields generated by the pole pins 12a, 12b of the two axial portions 10a, 10b virtually or even completely neutralize one another. Subsequently, no transmission or modulation of the alternating magnetic field generated by the first rotor 2a to the second rotor 2b, or vice versa, is brought about anymore. This means that torque is no longer transmitted between the two rotors 2a, 2b.

If the second axial portion 10b is in the second position, there is therefore no longer any drive connection between the two rotors 2a, 2b and the magnetic coupling 1 is in the freewheeling mode. This state is cancelled again by adjusting the second axial portion 10b back into the first position in such a way that the pole pins 12a, 12b which are adjacent along the axial direction exhibit respectively identical polarity. The drive coupling between the outer and inner rotors 4, 3 is then restored.

FIGS. 4 and 5 do not illustrate possible adjustment intermediate positions of the second axial portion 10 between the first and the second positions. Positioning in such an intermediate position permits the strength of the magnetic field generated by the axial portion magnet elements 11a, 11b of the stator 5 to be varied between a maximum value, when the second axial portion 10b is in the first position, and a minimum value, in an extreme case a zero value. In the latter case, the second axial portion 10b is, as already explained, in its second position.

As a result, the possibility of setting the second axial portion 10b to an intermediate position gives the magnetic coupling the property of being able to set the degree of coupling between the first and the second rotor 2a, 2b between a maximum value and a minimum value. If the minimum value is simultaneously a zero value, i.e. if there is no coupling present, the magnetic coupling 1 is in the freewheeling mode.

The functional principle, essential to the invention, of a stator which can be adjusted in two parts can be readily transferred to other structural embodiments of the magnetic coupling 1, for example with an outer stator or an inner stator instead of the central stator described above. In the preceding example, this means that in the case of an outer stator the latter is divided into a first axial portion and an adjustable second axial portion.

The magnetic coupling 1 which is explained with reference to FIGS. 1 to 5 and which has permanent magnets 8a, 8b on the casing 6 and on the shaft 13 of the outer and inner rotors 4, 3 as well as pole pins 12a, 12b on the intermediate wall 9 can also be transferred to other structural embodiments of the magnetic coupling 1.

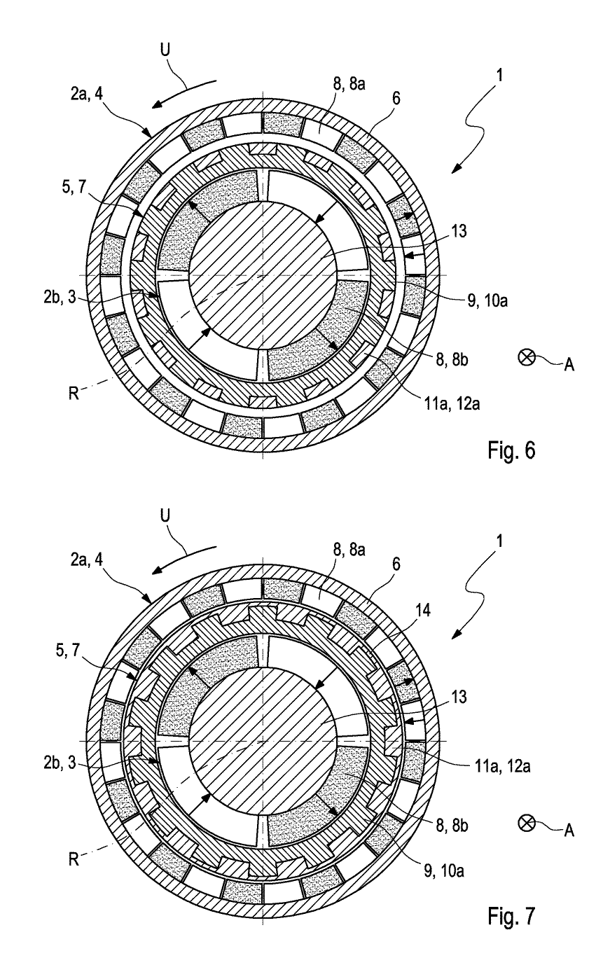

For the purpose of providing clarity, FIG. 6 illustrates the configuration shown in FIGS. 1 to 5 in a cross section which is defined by a plane which is arranged orthogonally with respect to the axial axis and lies axially in the region of the first axial portion 10a. The number of pole pairs formed by the permanent magnets 8a is referred to below as a, and the number of magnetic pole pairs formed by the permanent magnets 8b is referred to as i. In the illustrated example, a=12 and i=2.

The following applies to the number p of pole pins 12a: p=a+i, i.e. in the illustrated example 14 pole pins 12a are present.

Taking this exemplary embodiment as a basis, FIGS. 7 to 11 show structural modifications which all have in common the principle, essential to the invention, of a two-part stator, whether it be an outer stator, central stator or inner stator, with axial portions 10a, 10b which are adjustable relative to one another in the circumferential direction U.

FIG. 7 therefore shows a variant of the example in FIG. 6 in which the pole pins 12a on the intermediate wall 9 are connected to one another in a yoke-like fashion by means of a casing 14 made of ferromagnetic material. The functionality of this example corresponds to that in FIG. 6.

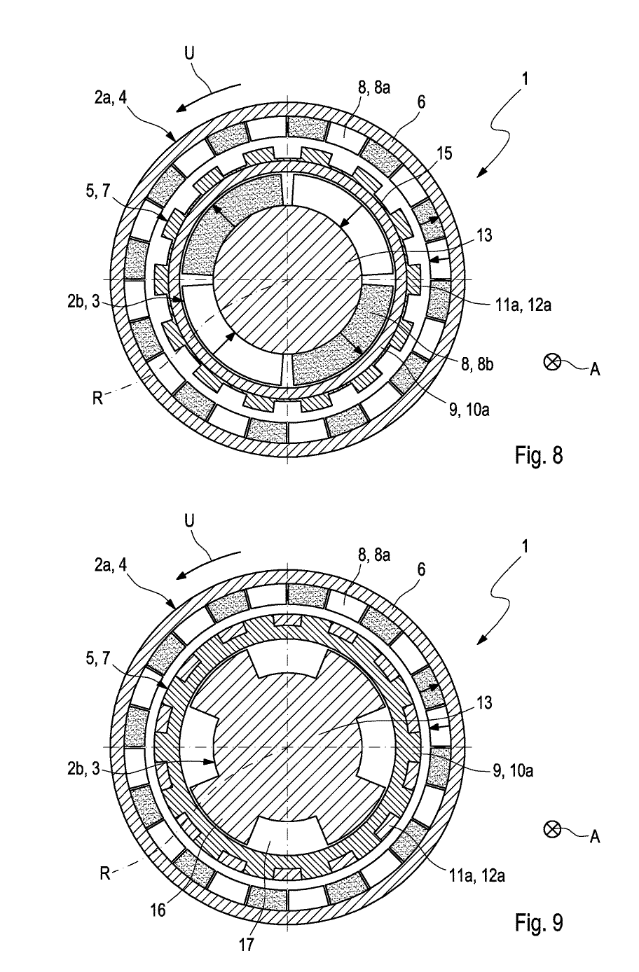

In the example in FIG. 8, the pole pins 12a are arranged in the form of external toothing on a casing 15 made of ferromagnetic material, wherein this casing 15 is arranged on the intermediate wall 9.

In the example scenario in FIG. 9, the outer rotor 4 with the rotor magnet elements 8, 8a is embodied in a way analogous to the example in FIG. 6. The same applies to the intermediate wall 9 with the pole pins 12a. In contrast, the inner rotor 3 in the scenario in FIG. 9 has, unlike the examples 5 explained hitherto, a body which is composed of ferromagnetic material with radially outwardly pointing teeth 16 and tooth gaps 17 arranged between them in the circumferential direction U, wherein the teeth and the tooth gaps can have approximately the same widths in the circumferential direction, said widths being formed in the example in FIG. 6 by the permanent magnets 8a with opposing radial magnetization. When the inner rotor 3 rotates, the outer rotor 4 of the example in FIG. 9 rotates in the opposite direction.

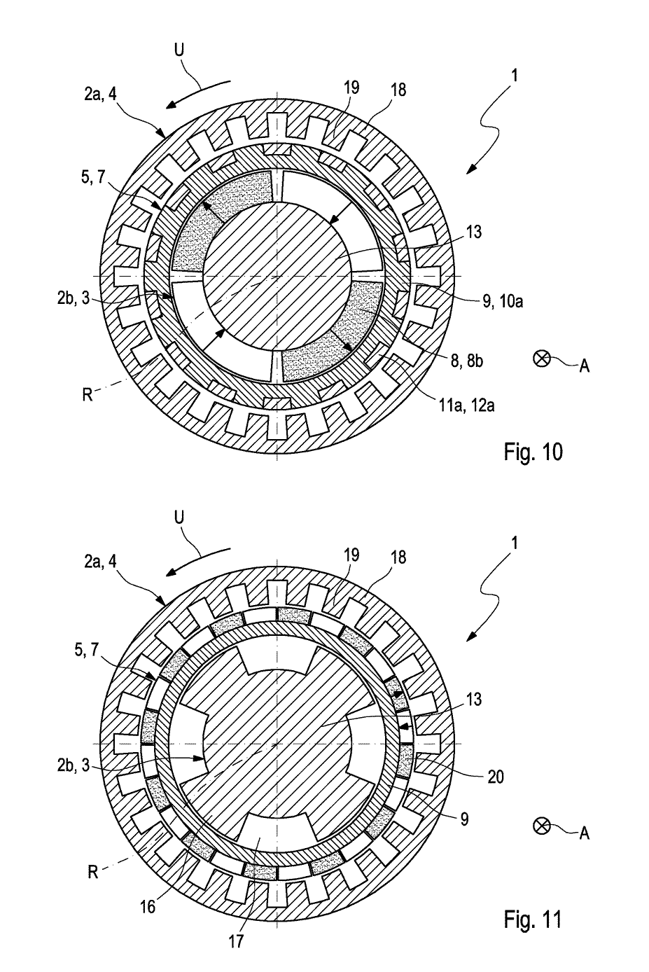

The example in FIG. 10 differs from that in FIG. 6 in that the outer rotor 4 is formed from a casing 18 made of ferromagnetic material and teeth 19 which are integrally formed thereon on the inner side, are directed radially inward and are made of ferromagnetic material.

The embodiment in FIG. 11 has, on the one hand, an inner rotor 3 corresponding to the example in FIG. 9 and, on the other hand, an outer rotor 4 according to the example in FIG. 10. In contrast to all the examples explained previously, permanent magnets 20 are arranged on the intermediate wall 9 and are each magnetized in the radial direction, wherein adjacent permanent magnets 20 have opposing magnetization.

FIG. 11 shows a variant in which permanently magnetized elements are arranged exclusively on the intermediate wall 9. The permanent magnets 20 can be embedded in a non-magnetizable plastic material which can be provided on the intermediate wall 9.

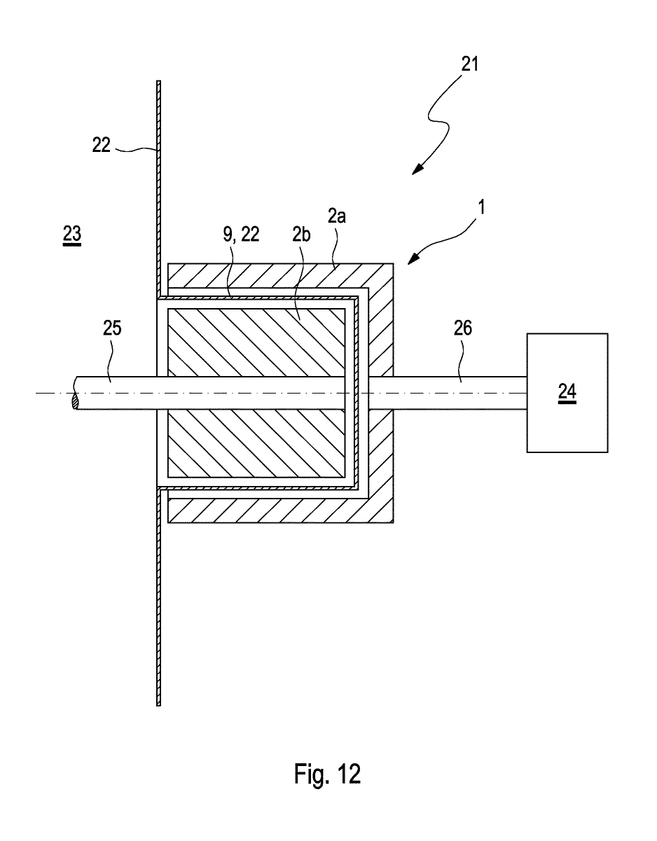

Finally, FIG. 12 shows an application example of the magnetic coupling 1 in the form of a magnetic gear mechanism as part of a device 21 for utilizing waste heat, in particular the waste heat of an exhaust system in motor vehicles. The device 21 comprises a high-revving turbine which is driven by the waste heat of a heated fluid. Said high-revving turbine is arranged in a region 23 which is closed off by a hermetically sealed partition 22 to prevent loss of fluid, and said high-revving turbine has, on the outside of the partition 22, a contact-free drive coupling on the output side to an apparatus 24 which is provided for utilizing the turbine work. The intermediate wall 9 (explained in conjunction with FIGS. 6 to 11, of the magnetic coupling 1 can be part of the partition 22 here.

The magnetic coupling 1 with a drive shaft 25 which is provided in the closed-off region and is connected in a rotationally fixed fashion to the second rotor 2b serves as an arrangement for the drive coupling. On the outside of the partition, an output shaft 26 is provided which is in turn connected in a rotationally fixed fashion to the first rotor 2a.

1. A magnetic coupling comprising:
a stator having a first axial portion which merges with a second axial portion along an axial direction, the second axial portion being adjustable relative to the first axial portion along a circumferential direction;
a first rotor rotationally adjustable relative to the stator about a rotational axis which runs along an axial direction; and
a second rotor arranged concentrically with respect to the first rotor and rotationally adjustable relative to the stator about the rotational axis;
wherein the first axial portion of the stator includes first axial portion magnet elements arranged in pairs having alternating magnetic polarity along the circumferential direction, and the second axial portion of the stator includes second axial portion magnet elements arranged in pairs having alternating magnetic polarity along the circumferential direction; and
wherein the first and second rotors each includes rotor magnet elements arranged in pairs having alternating magnetic polarity along the circumferential direction.

2. The magnetic coupling as claimed in claim 1, wherein at least one of the rotor magnet elements, the first axial portion magnet elements, and the second axial portion magnet elements have one of radial, lateral, and parallel magnetization.

3. The magnetic coupling as claimed in claim 1, wherein the first and second rotors and the stator are each embodied essentially in an annular shape and arranged concentrically with respect to the rotational axis in a cross section defined along the axial axis.

4. The magnetic coupling as claimed in claim 1, wherein:
the second axial portion is adjustable relative to the first axial portion between a first position and a second position in the circumferential direction; and
axial portion magnet elements, adjacent in the axial direction, of the first and second axial portions have the same polarity in the first position, and opposing polarities to one another in the second position.

5. The magnetic coupling as claimed in claim 4, wherein the second axial portion is adjustable into an intermediate position between the first and second positions.

6. The magnetic coupling as claimed in claim 1, wherein one of:
the first rotor is an inner rotor, the second rotor is a central rotor, and the stator is an outer stator arranged radially outside the inner rotor and the central rotor;
the first rotor is an outer rotor, the second rotor is an inner rotor, and the stator is a central stator arranged radially between the outer rotor and the inner rotor; or
the first rotor is a central rotor, the second rotor is an outer rotor, and the stator is an inner stator arranged radially inside the central rotor and the outer rotor.

7. The magnetic coupling as claimed in claim 6, wherein the rotor magnet elements of the central rotor or the first and second axial portion magnet elements of the central stator have pole pins extending along the axial direction, arranged at a distance from one another along the circumferential direction, and composed of a ferromagnetic material, wherein adjacent pole pins along the circumferential direction have opposing polarities to one another.

8. The magnetic coupling as claimed in claim 6, wherein at least one of:
the rotor magnet elements of the outer rotor or the first and second axial portion magnet elements of the outer stator are permanent magnets; and
the rotor magnet elements of the inner rotor or the first and second axial portion magnet elements of the inner stator are permanent magnets.

9. The magnetic coupling as claimed in claim 1, wherein the magnetic coupling is a magnetic gear mechanism.

10. The magnetic coupling as claimed in claim 9, wherein the magnetic gear mechanism is configured to step down a rotational speed of the first rotor.

11. A device for utilizing waste heat, comprising:
a high-revving turbine driven by a fluid heatable by the waste heat, the high-revving turbine being arranged in a region closed off by a hermetically sealed partition to prevent loss of fluid, and outside of the partition, the high-revving turbine having a contact-free drive coupling on an output side to an apparatus provided for utilizing turbine work;
a magnetic coupling provided as an arrangement for the drive coupling, the magnetic coupling having:
a stator having a first axial portion which merges with a second axial portion along an axial direction, the second axial portion being adjustable relative to the first axial portion along a circumferential direction;
a first rotor rotationally adjustable relative to the stator about a rotational axis which runs along an axial direction; and
a second rotor arranged concentrically with respect to the first rotor and rotationally adjustable relative to the stator about the rotational axis;
wherein the first and second axial portions of the stator and the first and second rotors each includes magnet elements arranged in pairs having alternating magnetic polarity along the circumferential;
a drive shaft provided in the closed-off region and connected in a rotationally fixed fashion to the second rotor; and
an output shaft connected in a rotationally fixed fashion to the first rotor and provided on the output side.

12. The device as claimed in claim 11, wherein the stator is an intermediate wall that is part of the partition.

13. A motor vehicle comprising a device for utilizing waste heat the device having:
a high-revving turbine driven by a fluid heatable by the waste heat, the high-revving turbine being arranged in a region closed off by a hermetically sealed partition to prevent loss of fluid, and outside of the partition, the high-revving turbine having a contact-free drive coupling on an output side to an apparatus provided for utilizing turbine work;
a magnetic coupling provided as an arrangement for the drive coupling, the magnetic coupling having:
a stator having a first axial portion which merges with a second axial portion along an axial direction, the second axial portion being adjustable relative to the first axial portion along a circumferential direction;
a first rotor rotationally adjustable relative to the stator about a rotational axis which runs along an axial direction; and
a second rotor arranged concentrically with respect to the first rotor and rotationally adjustable relative to the stator about the rotational axis;
wherein the first and second axial portions of the stator and the first and second rotors each includes magnet elements arranged in pairs having alternating magnetic polarity along the circumferential;
a drive shaft provided in the closed-off region and connected in a rotationally fixed fashion to the second rotor; and
an output shaft connected in a rotationally fixed fashion to the first rotor and provided on the output side.

14. The magnetic coupling as claimed in claim 2, wherein the first and second rotors and the stator are each embodied essentially in an annular shape and arranged concentrically with respect to the rotational axis in a cross section defined along the axial axis.

15. The magnetic coupling as claimed in claim 2, wherein:
the second axial portion is adjustable relative to the first axial portion between a first position and a second position in the circumferential direction; and
axial portion magnet elements, adjacent in the axial direction, of the first and second axial portions have the same polarity in the first position, and opposing polarities to one another in the second position.

16. The magnetic coupling as claimed in claim 15, wherein the second axial portion is adjustable into an intermediate position between the first and second positions.

17. The magnetic coupling as claimed in claim 3, wherein:
the second axial portion is adjustable relative to the first axial portion between a first position and a second position in the circumferential direction; and
axial portion magnet elements, adjacent in the axial direction, of the first and second axial portions have the same polarity in the first position, and opposing polarities to one another in the second position.

18. The magnetic coupling as claimed in claim 8, wherein the permanent magnets are radially magnetized.

19. The magnetic coupling as claimed in claim 7, wherein at least one of:
the rotor magnet elements of the outer rotor or the first and second axial portion magnet elements of the outer stator are permanent magnets; and
the rotor magnet elements of the inner rotor or the first and second axial portion magnet elements of the inner stator are permanent magnets.

20. The magnetic coupling as claimed in claim 19, wherein the permanent magnets are radially magnetized.
